(19) United States
(12) Patent Application Publication
(10) Pub. No.: US 2022/0019816 A1
(43) Pub. Date: Jan. 20, 2022

(54) INFORMATION PROCESSING APPARATUS, INFORMATION PROCESSING METHOD AND NON-TRANSITORY STORAGE MEDIUM

(71) Applicant: Toyota Jidosha Kabushiki Kaisha, Toyota-shi Aichi-ken (JP)

(72) Inventor: Ryota Osumi, Nagoya-shi (JP)

(21) Appl. No.: 17/371,652

(22) Filed: Jul. 9, 2021

(30) Foreign Application Priority Data
Jul. 14, 2020 (JP) 2020-120419

(51) Int. Cl. G06K 9/00; G06K 9/62

(52) U.S. Cl. CPC G06K 9/00798; G06K 9/6288

(57) ABSTRACT

An object of the present disclosure is to efficiently grasp conditions of lane markings on a road. A controller in an information processing apparatus receives, from each of a plurality of vehicles, a lane marking information piece in which an information piece relating to a position of the vehicle traveling on a road with a plurality of lanes and an information piece relating to presence or absence of lane markings defining a lane on which the vehicle is traveling are associated with each other. Also, the controller in the information processing apparatus acquires, from among the lane marking information pieces received from the plurality of vehicles, information pieces relating to presence or absence of a same lane marking at a same position and performs aggregation processing. Then, the controller detects fading of the lane marking based on a result of the aggregation processing.

### CROSS REFERENCE TO THE RELATED APPLICATION

This application claims the benefit of Japanese Patent Application No. 2020-120419, filed on Jul. 14, 2020, which is hereby incorporated by reference herein in its entirety.

### BACKGROUND

### Technical Field

The present disclosure relates to an information processing apparatus, an information processing method and a non-transitory storage medium.

### Description of the Related Art

Japanese Patent Laid-Open No. 2019-28939 discloses an estimation apparatus that estimates whether or not a while line is faded, based on road images of while lines picked up at a plurality of spots.

### SUMMARY

An object of the present disclosure is to efficiently grasp conditions of lane markings on a road.

An information processing apparatus according to a first aspect of the present disclosure includes a controller comprising at least one processor configured to:

receive, from each of a plurality of vehicles, a lane marking information piece in which an information piece relating to a position of the vehicle traveling on a road with a plurality of lanes and an information piece relating to presence or absence of lane markings defining a lane on which the vehicle is traveling are associated with each other;

acquire, from among the lane marking information pieces received from the plurality of vehicles, information pieces relating to presence or absence of a same lane marking at a same position and perform aggregation processing; and

detect fading of the lane marking based on a result of the aggregation processing.

An information processing method according to a second aspect of the present disclosure is an information processing method for a computer to execute, the information processing method including:

a step of acquiring, from among lane marking information pieces received from a plurality of vehicles traveling on a road with a plurality of lanes, in which information pieces relating to positions of the vehicles and information pieces relating to presence or absence of lane markings defining the lanes on which the vehicles are traveling are associated with each other, information pieces relating to presence or absence of a same lane marking at a same position;

a step of performing aggregation processing for the acquired lane marking information pieces relating to presence or absence of the same lane marking at the same position; and

a step of detecting fading of the lane marking based on a result of the aggregation processing.

A non-transitory storage medium according to a third aspect of the present disclosure is a non-transitory storage medium storing a program that causes a computer to execute an information processing method, the information processing method including:

a step of acquiring, from among lane marking information pieces received from a plurality of vehicles traveling on a road with a plurality of lanes, in which information pieces relating to positions of the vehicles and information pieces relating to presence or absence of lane markings defining the lanes on which the vehicles are traveling are associated with each other, information pieces relating to presence or absence of a same lane marking at a same position;

a step of performing aggregation processing for the acquired lane marking information pieces relating to presence or absence of the same lane marking at the same position; and

a step of detecting fading of the lane marking based on a result of the aggregation processing.

The present disclosure enables efficiently grasping conditions of lane markings on a road.

### BRIEF DESCRIPTION OF THE DRAWINGS

FIG. 1 is a diagram illustrating a schematic configuration of a detection system;

FIG. 2 is a block diagram schematically illustrating an example of a functional configuration of an in-vehicle device;

FIG. 3 is a diagram illustrating an example of a situation in which in-vehicle devices detect lane markings;

FIG. 4 is a diagram illustrating an example of a table configuration of lane marking information;

FIG. 5 is a block diagram schematically illustrating an example of a functional configuration of a management server;

FIG. 6 is a diagram illustrating an example of a table configuration of aggregated information stored in an aggregated information database in the first embodiment;

FIG. 7 is a flowchart of detection processing; and

FIG. 8 is a diagram illustrating an example of a table configuration of aggregated information stored in an aggregated information database in a second embodiment.

### DESCRIPTION OF THE EMBODIMENTS

The information processing apparatus according to the first aspect of the present disclosure is an information processing apparatus that manages lane markings on roads. The controller in the information processing apparatus according to the first aspect of the present disclosure receives, from each of a plurality of vehicle, a lane marking information piece in which an information piece relating to a position of the vehicle traveling on a road with a plurality of lanes and an information piece relating to presence or absence of lane markings defining a lane on which the vehicle is traveling are associated with each other. Consequently, the information processing apparatus can grasp presence or absence of lane markings at each position on each lane of a road with a plurality of lanes. Note that examples of a road with a plurality of lanes include a road with one lane on each side, that is a road with two lanes in opposite directions. Then, the controller in the information processing apparatus acquires, from the lane marking information pieces received from the plurality of vehicles, information pieces relating to presence or absence of a same lane marking at a same position and performs aggregation processing. Furthermore, the controller detects fading of the lane marking based on a result of the aggregation processing.

Lane markings on a road sometimes become unclear because of fading due to, e.g., age-related deterioration. If lane markings become unclear, problems such as difficulty in recognition of the lanes from traveling vehicles may occur. Therefore, a manager of a road needs to inspect whether or not lane markings on the road are faded. However, it needs a huge amount of labor for the manager itself to inspect whether or not fading occurs, at each of all positions on the lane markings on the road. Therefore, the information processing apparatus according to the present disclosure detects lane marking fading by receiving lane marking information pieces from a plurality of vehicles and performing aggregation processing. Consequently, a manager can recognize lane marking fading via the information processing apparatus, without the manager itself inspecting the lane markings on the road. In this way, the information processing apparatus enables efficiently grasp conditions of lane markings on a road.

Specific embodiments of the present disclosure will be described below with reference to the drawings. Dimensions, materials, shapes, relative dispositions, etc., of components described in the present embodiments are not intended to limit the technical scope of the present disclosure only thereto unless specifically noted otherwise.

### First Embodiment

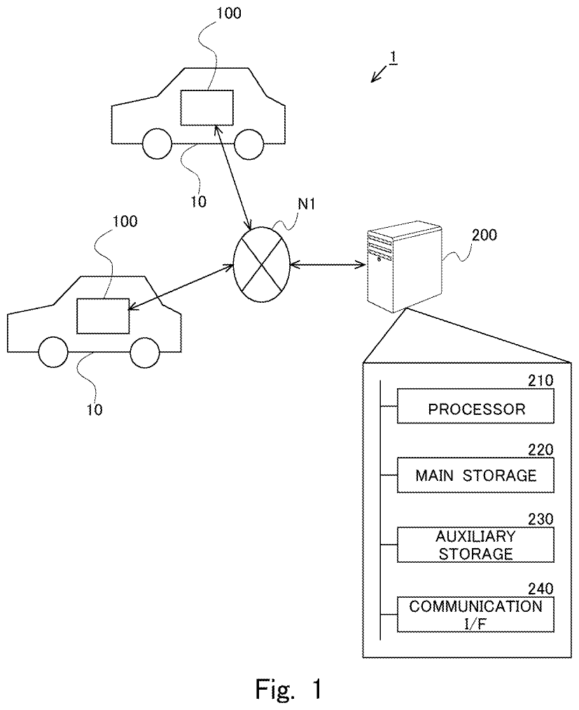

A detection system 1 in the present embodiment will be described with reference to FIG. 1. FIG. 1 is a diagram illustrating a schematic configuration of the detection system 1. The detection system 1 includes a plurality of in-vehicle devices 100 and a management server 200. Here, the detection system 1 is a system for detecting lane marking fading on a road. A manager of a road needs to inspect whether or not lane markings on the road are faded. However, it needs a huge amount of labor for the manager itself to inspect whether or not fading occurs, at each of all positions on the lane markings on the road. Therefore, the manager of the road grasps lane marking fading using the detection system 1.

The in-vehicle devices 100 are respective devices mounted in the plurality of vehicles 10. Each in-vehicle device 100 is a device that detects lane markings of a lane on which a vehicle 10 with the in-vehicle device 100 mounted therein is traveling. The lane markings detected by each in-vehicle device 100 are lane markings on the right and left side of the lane on which the vehicle 10 with the in-vehicle device 100 mounted therein is traveling. The lane markings include a road center line, lane boundary lines and road edge lines. Each in-vehicle device 100 is, for example, a lane keeping assistant system or a lane departure prevention system in a vehicle 10 with the in-vehicle device 100 mounted therein.

The management server 200 is a server that manages lane markings on roads. The management server 200 includes a computer including a processor 210, a main storage 220, an auxiliary storage 230 and a communication interface (communication I/F) 240. The processor 210 is, for example, a CPU (central processing unit) or a DSP (digital signal processor). The main storage 220 is, for example, a RAM (random access memory). The auxiliary storage 230 is, for example, a ROM (read only memory). Also, the auxiliary storage 230 is, for example, an HDD (hard disk drive) or a disk recording medium such as a CD-ROM, a DVD disk or a Blu-ray disk. Also, the auxiliary storage 230 may be a removable medium. Here, examples of the removable medium include a USB memory and an SD card. The communication I/F 240 is, for example, a LAN (local area network), an interface board or a radio communication circuit for radio communication.

In the auxiliary storage 230 of the management server 200, e.g., an operating system (OS), various programs and various information tables are stored. Also, in the management server 200, various functions, such as those described below, can be implemented by the processor 210 loading the programs stored in the auxiliary storage 230 into the main storage 220 and executing the programs. However, some or all of the functions of the management server 200 may be implemented by a hardware circuit such as an ASIC or an FPGA. Note that the management server 200 does not necessarily need to be implemented by a single physical configuration but may be configured by a plurality of computers linked with each other. The management server 200 in the present embodiment corresponds to the “information processing apparatus” according to the first aspect of the present disclosure.

In the detection system 1, the in-vehicle devices 100 and the management server 200 are connected to each other via a network N1. For the network N1, for example, a WAN (wide area network) that is a worldwide public communication network such as the Internet, or a telephone communication network for, e.g., mobile phones may be employed.

(System Configuration)

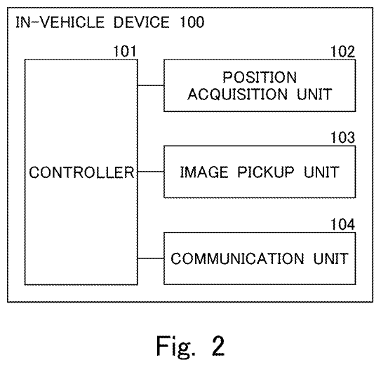

Next, respective functional configurations of the in-vehicle devices 100 and the management server 200 included in the detection system 1 according to the present embodiment will be described with reference to FIGS. 2 to 6.

(In-Vehicle Device 100)

FIG. 2 is a block diagram schematically illustrating an example of a functional configuration of an in-vehicle device 100. The in-vehicle device 100 includes a controller 101, a position acquisition unit 102, an image pickup unit 103 and a communication unit 104. The controller 101 has a function that performs arithmetic processing for controlling the in-vehicle device 100. The controller 101 can be implemented by a processor in the in-vehicle device 100.

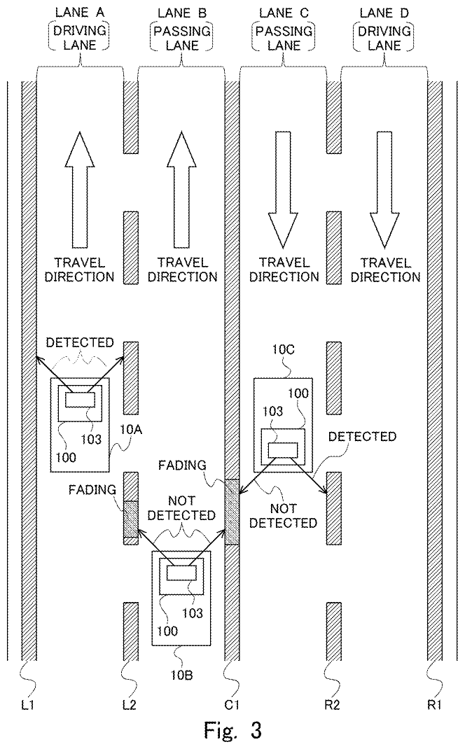

The image pickup unit 103 has a function that picks up an image of lane markings of a lane on which the relevant vehicle 10 is traveling. The image pickup unit 103 is implemented by a camera in the in-vehicle device 100. The controller 101 detects lane markings of a lane on which the vehicle 10 is traveling, based on an image or a moving image of the road picked up by the image pickup unit 103. FIG. 3 is a diagram illustrating an example of a situation in which in-vehicle devices 100 detect lane markings. In the example illustrated in FIG. 3, three vehicles 10 (a vehicle 10A, a vehicle 10B and a vehicle 10C) are traveling on a road. Also, in the example illustrated in FIG. 3, on the road, a total of four lanes, two lanes (lane A and lane B) whose travel direction is the upward direction on the sheet and two lanes (lane C and lane D) whose travel direction is the downward direction on the sheet, are provided. In other words, the road on which the three vehicles 10 are traveling is a road with two lanes on each side, on which driving lanes (lane A and lane D) and passing lanes (lane B and lane C) are provided.

As illustrated in FIG. 3, in the in-vehicle device 100 of the vehicle 10A traveling on the lane A, the image pickup unit 103 picks up an image or a moving image of a location at which lane markings defining lane A, that is, a lane marking L1 on the left side, and a lane marking L2 on the right side, of lane A are present. Then, in the in-vehicle device 100 of the vehicle 10A, the controller 101 detects the left-side lane marking L1 and the right-side lane marking L2 of lane A based on the image picked up by the image pickup unit 103. Note that if the lane on which the vehicle 10A is traveling is changed from lane A to lane B, the in-vehicle device 100 of the vehicle 10A picks up an image or a moving image of a location at which the lane marking L2 on the left side, and a lane marking C1 on the right side, of lane B are present and detects the lane marking L2 and the lane marking C1.

Also, likewise, in the in-vehicle device 100 of the vehicle 10B traveling on lane B, the image pickup unit 103 picks up an image or a moving image of a location at which lane markings defining lane B, that is, the lane marking L2 on the left side, and the lane marking C1 on the right side, of lane B are present. Then, in the in-vehicle device 100 of the vehicle 10B, the controller 101 detects the lane marking L2 on the left side, and the lane marking C1 on the right side, of lane B based on the image or the moving image picked up by the image pickup unit 103. Also, in the in-vehicle device 100 in the vehicle 10C traveling on lane C, the image pickup unit 103 picks up an image or a moving image of a location at which lane markings defining lane C, that is, a lane marking R2 on the left side, and the lane marking C1 on the right side, of lane C are present. Then, in the in-vehicle device 100 of the vehicle 100, the controller 101 detects the lane marking R2 on the left side, and the lane marking C1 on the right side, of lane C based on the image or the moving image picked up by the image pickup unit 103.

However, lane markings on a road sometimes are faded because of aging. For example, as a result of vehicles running on a lane marking, the lane marking is worn and thus faded. Also, for example, as a result of a lane marking being deteriorated because of being weathered, the lane marking is faded. Here, in the example in FIG. 3, the lane marking L2 and the lane marking C1 are partly faded. Note that a position at which the lane marking L2 is faded and a position at which the lane marking C2 is faded are substantially the same (located side by side). In this way, if a lane marking is faded, a controller 101 cannot detect the lane marking based on an image or a moving image picked up of a location at which the fading has occurred.

Here, in FIG. 3, the in-vehicle device 100 of the vehicle 10B picks up an image or a moving image of a location at which the lane marking L2 and the lane marking C2 are faded. Therefore, when the vehicle 10B is traveling through the position illustrated in FIG. 3, the controller 101 of the in-vehicle device 100 in the vehicle 10B cannot detect the lane marking on the left side, and the lane marking on the right side, of lane B. On the other hand, in FIG. 3, the in-vehicle device 100 of the vehicle 10A picks up an image or a moving image of a location at which neither the lane marking L1 nor the lane marking L2 is faded. Therefore, when the vehicle 10A is traveling through the position illustrated in FIG. 3, the controller 101 of the in-vehicle device 100 in the vehicle 10A can detect the lane marking on the left side, and the lane marking on the right side, of lane A. However, the controller 101 of the in-vehicle device 100 in the vehicle 10A cannot detect the lane marking on the right side of lane A at a position at which the lane marking L2 is faded. Also, in FIG. 3, the in-vehicle device 100 of the vehicle 10C picks up an image or a moving image of a location at which the lane marking R2 is not faded but the lane marking C2 is faded. Therefore, when the vehicle 10C is traveling through the position illustrated in FIG. 3, the controller 101 of the in-vehicle device 100 in the vehicle 10C can detect the lane marking on the left side of lane C but cannot detect the lane marking on the right side of lane C.

In this way, at a position at which a lane marking is faded, the controller 101 cannot detect the lane marking based on an image or a moving image of the relevant road picked up by the image pickup unit 103. Therefore, in the present embodiment, the controller 101 generates information relating to detection or non-detection of lane markings by the controller 101, as information relating to presence or absence of the lane markings.

The position acquisition unit 102 has a function that acquires a current position of the vehicle 10. The position acquisition unit 102 is implemented by a GPS receiver. The controller 101 acquires a position of the vehicle 10 when the image pickup unit 103 picked up an image or a moving image of a location at which lane markings are present, from the position acquisition unit 102.

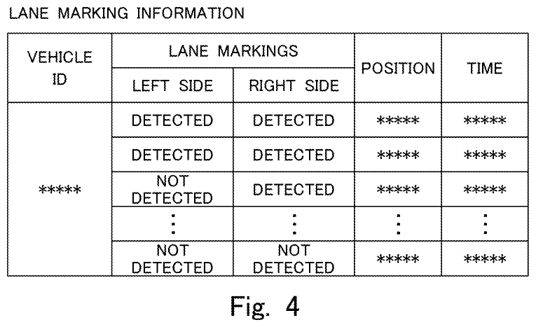

The controller 101 generates lane marking information in which information relating to a position through which the vehicle 10 is traveling and information relating to detection or non-detection of lane markings on the left and right sides of a lane on which the vehicle 10 is traveling are associated with each other. FIG. 4 is a diagram illustrating an example of a table configuration of lane marking information. As illustrated in FIG. 4, the table of lane marking information includes a vehicle ID field, lane marking fields, position fields and time fields. An identifier for identifying the vehicle 10 with the in-vehicle device 100 mounted therein is entered in the vehicle ID field. Respective information pieces relating to detection or non-detection of lane markings on the left and right sides of a lane on which the vehicle 10 is traveling are entered in the lane marking fields. In each lane marking field, if the controller 101 detects the relevant lane marking, “detected” is entered, and if the controller 101 does not detect the relevant lane marking, “not detected” is entered. Also, information on a position of the vehicle 10 when the image pickup unit 103 picked up an image or a moving image of the relevant road is entered in each position field. For example, coordinates such as a latitude and a longitude are entered in each position field. Also, a time (a time and a date) when the image pickup unit 103 picked up the image or the moving image of the road for lane marking detection is entered in each time field.

The communication unit 104 has a function that connects the in-vehicle device 100 to the network N1. The communication unit 104 can be implemented by a communication I/F of the in-vehicle device 100. The controller 101 transmits the lane marking information to the management server 200 via the communication unit 104.

(Management Server)

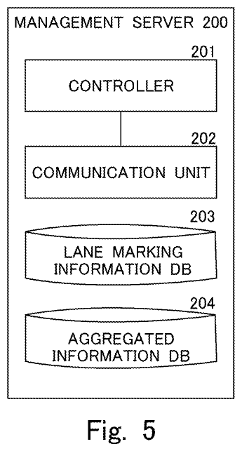

FIG. 5 is a block diagram schematically illustrating an example of a functional configuration of the management server 200. The management server 200 includes a controller 201, a communication unit 202, a lane marking information database (lane marking information DB) 203 and an aggregated information database (aggregated information DB) 204.

The controller 201 has a function that performs arithmetic processing for controlling the management server 200. The controller 201 can be implemented by the processor 210 of the management server 200. The communication unit 202 has a function that connects the management server 200 to the network N1. The communication unit 202 can be implemented by the communication I/F 240 of the management server 200. The controller 201 receives lane marking information pieces from the respective in-vehicle devices 100 via the communication unit 202.

The lane marking information DB 203 has a function that stores the lane marking information pieces received from the respective in-vehicle devices 100. The lane marking information DB 203 can be implemented by the auxiliary storage 230 of the management server 200.

The controller 201 acquires, from the lane marking information pieces stored in the lane marking information DB 203, information pieces relating to presence or absence of a same lane marking at a same position and performs aggregation processing. More specifically, the controller 201 acquires positions of the vehicles 10 based on the lane marking information pieces stored in the lane marking information DB 203. Based on the acquired positions of the vehicles 10, the controller 201 identifies a lane on which each vehicle 10 was traveling when presence or absence of lane markings was detected. Then, the controller 201 performs aggregation processing based on lane marking information pieces relating to a same lane. In more detail, the controller 201 generates aggregated information, which is information aggregated with regard to detection or non-detection of lane markings on the left and right sides at a same position, for each of the lanes thus identified. Then, the controller 201 stores the aggregated information generated via the aggregation processing, in the aggregated information DB 204. Note that the aggregated information DB 204 can be implemented by the auxiliary storage 230 of the management server 200.

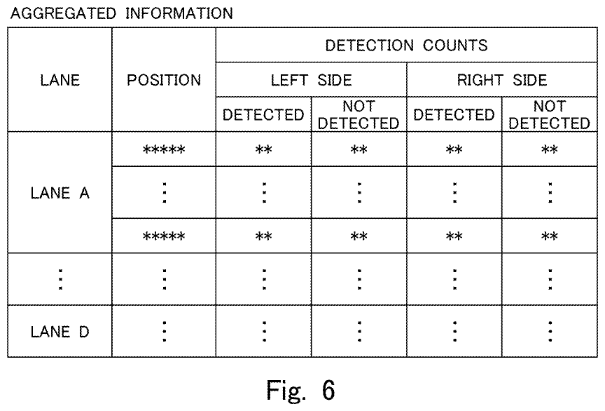

FIG. 6 is a diagram illustrating an example of a table configuration of aggregated information stored in the aggregated information DB 204 in the present embodiment. As illustrated in FIG. 6, the table of the aggregated information includes lane fields, position fields and detection count fields. Information pieces for identifying respective lanes on the road are entered in the lane fields. The respective positions entered in the position fields in the lane marking information pieces received from the plurality of in-vehicle devices 100 are entered in the position fields. Here, the positions entered in the respective position fields in the lane marking information pieces received from the plurality of in-vehicle devices 100 are entered in the position fields in association with the respective lanes. Information aggregated with regard to detection or non-detection of a lane marking for a same lane in the lane marking information pieces received from the plurality of in-vehicle devices 100 is entered in each detection count field. More specifically, counts of “detected” and “not detected” entered in the lane marking fields in the lane marking information pieces received from the plurality of in-vehicle devices 100, which are associated with each of the respective positions entered in the position fields in the aggregated information, are entered in the detection count fields. Also, the counts of “detected” and “not detected” for left-side lane markings of the respective lanes and the counts of “detected” and “not detected” for right-side lane markings of the respective lanes are entered in the detection count fields. Note that the controller 201 acquires, from the lane marking information pieces received from the plurality of in-vehicle devices 100, information pieces relating to detection or non-detection of the respective lane markings during a predetermined period of time, based on the times entered in the time fields and performs aggregation processing.

The controller 201 detects lane marking fading based on the aggregated information stored in the aggregated information DB 204. More specifically, if a rate of “detected” for a certain position is equal to or lower than a predetermined rate in the aggregated information, the controller 201 determines that the lane marking is faded at the position. In the below, a position for which the rate of the detection is equal to or below a predetermined rate may be referred to as “position of (the) fading”.

Also, the controller 201 generates detection information including information identifying a lane for which fading of a lane marking was detected and the lane marking, and a position of the fading. Here, information identifying a lane marking is, e.g., an identifier for identifying a lane marking. Also, information for identifying a lane marking may be information relating to on which side of a lane the rate of detection is equal to or lower than a predetermined rate or information that the rate of detection on each of opposite sides of a lane is equal to or lower than a predetermined rate. The detection information enables the manager of the road to recognize that a lane marking is faded.

(Flow of Detection Processing)

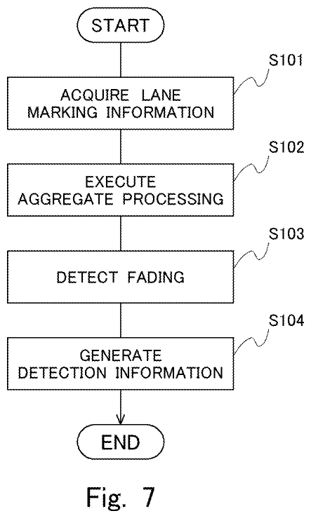

Next, detection processing performed by the controller 201 of the management server 200 in the detection system 1 will be described with reference to FIG. 7. FIG. 7 is a flowchart of detection processing. Detection processing is processing for detecting a faded lane marking. Detection processing is started by, for example, a manager that manages the management server 200 (manager of a road) making the management server 200 execute a program for detection processing. Also, the detection processing may be started by coming of a predetermined period such as a period of several months.

In the detection processing, first, in S101, lane marking information pieces relating to a same lane are acquired from the lane marking information DB 203. Next, in S102, aggregation processing is performed. At this time, aggregated information is generated and stored in the aggregated information DB 204. Next, in S103, based on the aggregated information, fading of lane markings is detected. Then, in S104, detection information for the lane marking fading detected in S103 is generated and the detection processing ends.

As described above, in the detection system 1, the management server 200 receives lane marking information pieces from the plurality of vehicles 10 and performs aggregation processing. Then, the management server 200 detects lane marking fading and generates detection information. Consequently, a manager of a road can recognize that the lane marking fading has occurred, via the detection system 1 without the manager itself inspecting lane markings on the road. In this way, the detection system 1 enables efficiently grasping conditions of lane markings on a road.

(Alternations)

In the present embodiment, each in-vehicle device 100 generates information relating to detection or non-detection of lane markings by the relevant controller 101 as information relating to presence or absence of the lane markings and transmits the information to the management server 200. However, information relating to presence or absence of lane markings may be an image or a moving image picked up by the relevant image pickup unit 103. In this case, based on the image or the moving image included in lane marking information, the controller 201 of the management server 200 determines whether or not lane markings on the right and left sides of a lane on which a vehicle 10 is traveling with the in-vehicle device 100 mounted therein can be detected. Then, the controller 201 stores information relating to whether or not the lane markings can be detected (detection or non-detection of the lane markings), in the lane marking information DB 203. Then, as in the first embodiment, the controller 201 performs aggregation processing based on lane marking information pieces stored in the lane marking information DB 203, the lane marking information pieces being received from the in-vehicle devices 100.

Also, in the present embodiment, if a rate of “detected” for a certain position in aggregated information is equal to or below a predetermined rate, the management server 200 determines that a lane marking is faded at the position. At this time, based on the rate of “detected” for the certain position in the aggregated information, the management server 200 may estimate a possibility of the lane marking being faded at the position. More specifically, based on the rate of “detected” for the certain position, the management server 200 may evaluate the possibility of the lane marking being faded at the position as any of levels. The possibility of the lane marking being faded is evaluated as, for example, any of levels of high, intermediate and low.

Also, each in-vehicle device 100 may transmit lane marking information further including information for identifying a lane on which a vehicle 10 is traveling with the in-vehicle device 100 mounted therein to the management server 200. In this case, the management server 200 acquires lane marking information pieces relating to a same lane based on the information pieces for identifying a lane in the lane marking information pieces received from the in-vehicle devices 100 and stored in the lane marking information DB 203 and performs aggregation processing. Also, lane marking information may include information indicating a travel direction of a relevant vehicle 10. Information indicating a travel direction of a relevant vehicle 10 is, for example, information relating to whether a lane on which the vehicle 10 is traveling is an inbound lane or an outbound lane or information relating to a direction in which the vehicle 10 is traveling. Through the information indicating the travel direction of the vehicle 10, the management server 200 can grasp on which lane of a road with one lane on each side (road with two lanes in opposite directions) the vehicle 10 is traveling. Therefore, the management server 200 acquires lane marking information pieces relating to a same lane based on the information pieces each indicating the travel direction of the relevant vehicle 10 and performs aggregation processing. Also, information relating to a position of a vehicle 10 when the relevant image pickup unit 103 picked up an image or a moving image of a road, the information being included in lane marking information, may be information relating to a road link of a road on which the vehicle 10 is traveling. In this case, also, the management server 200 can grasp the position of the vehicle 10 when the image pickup unit 103 picked up an image or a moving image of the road.

### Second Embodiment

The present embodiment is different from the first embodiment in that a management server 200 performs aggregation processing with lane markings of two adjacent lanes, the lane markings being the same, regarded as a single lane. In the below, only differences from the first embodiment will be described.

A controller 201 performs aggregation processing based on information pieces relating to presence or absence of a lane marking shared by two adjacent lanes of a plurality of lanes, the information pieces being included in respective lane marking information pieces relating to the two adjacent lanes. More specifically, as in the first embodiment, the controller 201 identifies respective lanes on which vehicles 10 are traveling, based on lane marking information pieces included in a lane marking information DB 203. Then, the controller 201 identifies two adjacent lanes of the plurality of lanes thus identified. Then, the controller 201 performs aggregation processing based on information pieces relating to presence or absence of a lane marking shared by the two adjacent lanes to generate aggregated information.

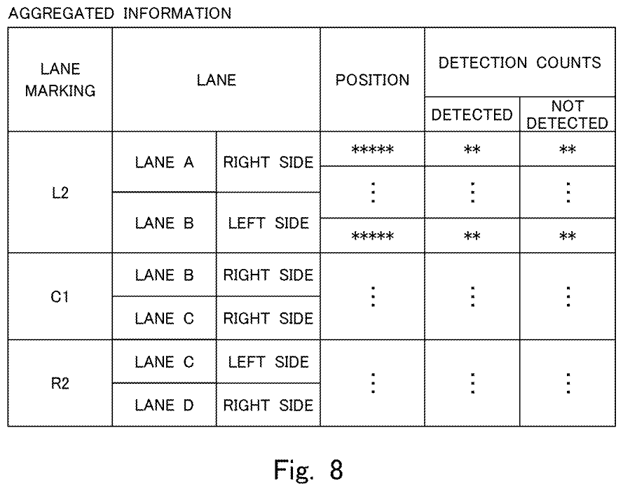

FIG. 8 is a diagram illustrating an example of a table configuration of aggregated information stored in an aggregated information DB 204 in the present embodiment. As illustrated in FIG. 8, the table of the aggregated information includes lane marking fields, lane fields, position fields and detection count fields. In each lane marking field, information for identifying a lane marking on a road. In each lane field, information for identifying two adjacent lanes sharing the relevant lane marking and information relating to on which side of each of the lanes the relevant lane marking is present are entered. In the position fields, positions entered in the position fields in lane marking information pieces received from the plurality of in-vehicle devices 100 are entered in association with the respective lanes. In each detection count field, information aggregated with regard to detection or non-detection of the lane marking shared by the two adjacent lanes is entered. More specifically, in each detection count field, counts of “detected” and “not detected” for respective positions of the shared lane marking are entered based on information pieces in the lane marking fields in the lane marking information pieces received from the plurality of in-vehicle devices 100.

There are cases where two adjacent lanes are lanes whose travel directions are the same and a lane marking on the left side of one lane and a lane marking on the right side of the other lane are the same. In this case, the controller 201 performs aggregation processing based on information pieces relating to presence or absence of the lane marking on the left side of the one lane and information pieces relating to presence or absence of the lane marking on the right side of the other lane. The example illustrated in FIG. 8 indicates aggregated information where the road illustrated in FIG. 3 is assumed. In the example illustrated in FIG. 8, the lane marking L2 is a lane marking shared by lane A and lane B adjacent to each other. Therefore, in the lane field, “lane A” and “lane B” are entered. Also, lane A and lane B are two lanes whose travel directions are the same. In other words, the lane marking L2 shared by lane A and lane B is the lane marking on the right side of lane A and is the lane marking on the left side of the lane B. Therefore, in the lane field, “right side” is entered in association with “lane A”. Also, in the lane field, “left side” is entered in association with “lane B”. Then, in the detection count field, a sum of the counts of “detected” and a sum of the counts of “not detected” for respective positions on the right side of lane A and on the left side of lane B are entered based on the lane marking information pieces received from the plurality of in-vehicle devices 100.

Also, there are cases where two adjacent lanes are lanes whose travel directions are opposite to each other and a lane marking on the right side of one lane and a lane marking on the right side of the other lane are the same. In such cases, the controller 201 performs aggregation processing based on information pieces relating to presence or absence of the lane marking on the right side of the one lane and information pieces relating to presence or absence of the lane marking on the right side of the other lane. In the example illustrated in FIG. 8, the lane marking C1 is a lane marking shared by lane B and lane C adjacent to each other. Therefore, in the lane field, “lane B” and “lane C” are entered. Also, lane B and lane C are two lanes whose travel directions are opposite to each other. In other words, the lane marking C1 shared by lane B and lane C is the lane marking on the right side of lane B and is the lane marking on the right side of lane C. Therefore, in the lane field, “right side” is entered in association with “lane B”. Also, in the lane field, “right side” is entered in association with “lane C”.

Then, in the detection count field, a sum of the counts of “detected” and a sum of the counts of “not detected” for respective positions on the right side of lane A and the right side of lane B are entered based on the lane marking information pieces received from the plurality of in-vehicle devices 100.

In the present embodiment, as illustrated in FIG. 3, vehicles 10 drive on the left side. Therefore, where travel directions of two adjacent lanes are opposite to each other, the controller 201 performs aggregation processing based on information pieces relating to presence or absence of a lane marking on the right side of one lane and information pieces relating to presence or absence of a lane marking on the right side of the other lane. However, where vehicles 10 drive on the right side (for example, where vehicles 10 travel in a country where vehicles drive on the right side of a road), if travel directions of two adjacent lanes are opposite to each other, the controller 201 performs aggregation processing based on information pieces relating to presence or absence of a lane marking on the left side of one lane and information pieces relating to presence or absence of a lane marking on the left side of the other lane.

As in the first embodiment, the controller 201 detects lane marking fading based on aggregated information stored in the aggregated information DB 204. Then, the controller 201 generates detection information identifying two lanes from which fading a lane marking was detected and the lane marking, and a position of the fading.

The flow of detection processing in the present embodiment is the same as that of first embodiment and description thereof will be omitted.

As in the first embodiment, the present embodiment enables efficiently grasping conditions of lane markings on a road via the detection system 1.

### Other Embodiments

Each of the above-described embodiments is definitely an example and the present disclosure can be implemented with appropriate changes made thereto without departing from the spirit thereof. Also, the processes and measures described in the present disclosure can freely be combined as long as such combination causes no technical contraction.

Also, processing described as being performed by a single apparatus may be shared by a plurality of apparatuses. Alternatively, processes described as being performed by different apparatuses may be performed by a single apparatus. In a computer system, what hardware configuration (server configuration) to be employed to implement the respective functions can flexibly be changed.

The present disclosure can be implemented by supplying computer programs for implementing the functions described in the above embodiments to a computer and making one or more processors included in the computer read and execute the programs. Such computer programs may be provided to the computer via a non-transitory computer-readable storage medium that is connectable to a system bus of the computer or may be provided to the computer via a network. Examples of the non-transitory computer-readable storage medium include arbitrary types of disks such as a magnetic disk (e.g., a floppy (registered trademark) disk or a hard disk drive (HDD)) and an optical disk (e.g., a CD-ROM, a DVD disk or a Blu-ray disk) and arbitrary types of mediums suitable for storing electronic commands, such as a read only memory (ROM), a random-access memory (RAM), an EPROM, an EEPROM, a magnetic card, a flash memory and an optical card.

What is claimed is:

1. An information processing apparatus comprising a controller comprising at least one processor configured to:
receive, from each of a plurality of vehicles, a lane marking information piece in which an information piece relating to a position of the vehicle traveling on a road with a plurality of lanes and an information piece relating to presence or absence of lane markings defining a lane on which the vehicle is traveling are associated with each other;
acquire, from among the lane marking information pieces received from the plurality of vehicles, information pieces relating to presence or absence of a same lane marking at a same position and perform aggregation processing; and
detect fading of the lane marking based on a result of the aggregation processing.

2. The information processing apparatus according to claim 1, wherein the controller performs the aggregation processing based on the lane marking information pieces relating to a same lane.

3. The information processing apparatus according to claim 1, wherein the controller performs the aggregation processing based on information pieces relating to presence or absence of a lane marking shared by two adjacent lanes of the plurality of lanes, the information pieces being included in the respective lane marking information pieces relating to the two adjacent lanes.

4. The information processing apparatus according to claim 3, wherein where the two adjacent lanes are lanes whose travel directions are same, if a lane marking on a left side of one lane and a lane marking on a right side of another lane are same, the controller performs the aggregation processing based on information pieces relating to presence or absence of the lane marking on the left side of the one lane and information pieces relating to presence or absence of the lane marking on the right side of the other lane.

5. The information processing apparatus according to claim 3, wherein
where the two adjacent lanes are lanes whose travel directions are opposite to each other,
if a lane marking on a right side of one lane and a lane marking on a right side of another lane are same, the controller performs the aggregation processing based on information pieces relating to presence or absence of the lane marking on the right side of the one lane and information pieces relating to presence or absence of the lane marking on the right side of the other lane, and
if a lane marking on a left side of one lane and a lane marking on a left side of another lane are same, the controller performs the aggregation processing based on information pieces relating to presence or absence of the lane marking on the left side of the one lane and information pieces relating to presence or absence of the lane marking on the left side of the other lane marking.

6. The information processing apparatus according to claim 1, wherein the controller detects fading of the lane marking based on a rate of detection for the lane marking in a result of the aggregation processing.

7. The information processing apparatus according to claim 1, wherein:
each lane marking information piece further includes information relating to times corresponding to the positions of the vehicle; and
the controller acquires information pieces relating to detection or non-detection of a same lane marking at a same position during a predetermined period of time from the lane marking information pieces received from the plurality of vehicles and performs the aggregation processing.

8. An information processing method for a computer to execute, the information processing method comprising:
a step of acquiring, from among lane marking information pieces received from a plurality of vehicles traveling on a road with a plurality of lanes, in which information pieces relating to positions of the vehicles and information pieces relating to presence or absence of lane markings defining the lanes on which the vehicles are traveling are associated with each other, information pieces relating to presence or absence of a same lane marking at a same position;
a step of performing aggregation processing for the acquired lane marking information pieces relating to presence or absence of the same lane marking at the same position; and
a step of detecting fading of the lane marking based on a result of the aggregation processing.

9. The information processing method according to claim 8, wherein the aggregation processing is performed based on the lane marking information pieces relating to a same lane.

10. The information processing method according to claim 8, wherein the aggregation processing is performed based on information pieces relating to presence or absence of a lane marking shared by two adjacent lanes of the plurality of lanes, the information pieces being included in the respective lane marking information pieces relating to the two adjacent lanes.

11. The information processing method according to claim 10, wherein where the two adjacent lanes are lanes whose travel directions are same, if a lane marking on a left side of one lane and a lane marking on a right side of another lane are same, the aggregation processing is performed based on information pieces relating to presence or absence of the lane marking on the left side of the one lane and information pieces relating to presence or absence of the lane marking on the right side of the other lane.

12. The information processing method according to claim 10, wherein
where the two adjacent lanes are lanes whose travel directions are opposite to each other,
if a lane marking on a right side of one lane and a lane marking on a right side of another lane are same, the aggregation processing is performed based on information pieces relating to presence or absence of the lane marking on the right side of the one lane and information pieces relating to presence or absence of the lane marking on the right side of the other lane, and
if a lane marking on a left side of one lane and a lane marking on a left side of another lane are same, the aggregation processing is performed based on information pieces relating to presence or absence of the lane marking on the left side of the one lane and information pieces relating to presence or absence of the lane marking on the left side of the other lane marking.

13. The information processing method according to claim 8, wherein fading of the lane marking is detected based on a rate of detection for the lane marking in a result of the aggregation processing.

14. The information processing method according to claim 8, wherein:
each lane marking information piece further includes information relating to times corresponding to the positions of the vehicle; and
information pieces relating to detection or non-detection of a same lane marking at a same position during a predetermined period of time is acquired from the lane marking information pieces received from the plurality of vehicles and the aggregation processing is performed.

15. A non-transitory storage medium storing a program that causes a computer to execute an information processing method, the information processing method comprising:
a step of acquiring, from among lane marking information pieces received from a plurality of vehicles traveling on a road with a plurality of lanes, in which information pieces relating to positions of the vehicles and information pieces relating to presence or absence of lane markings defining the lanes on which the vehicles are traveling are associated with each other, information pieces relating to presence or absence of a same lane marking at a same position;
a step of performing aggregation processing for the acquired lane marking information pieces relating to presence or absence of the same lane marking at the same position; and
a step of detecting fading of the lane marking based on a result of the aggregation processing.

16. The non-transitory storage medium according to claim 15, wherein in the information processing method, the aggregation processing is performed based on the lane marking information pieces relating to a same lane.

17. The non-transitory storage medium according to claim 15, wherein in the information processing method, the aggregation processing is performed based on information pieces relating to presence or absence of a lane marking shared by two adjacent lanes of the plurality of lanes, the information pieces being included in the respective lane marking information pieces relating to the two adjacent lanes.

18. The non-transitory storage medium according to claim 17, wherein in the information processing method, where the two adjacent lanes are lanes whose travel directions are same, if a lane marking on a left side of one lane and a lane marking on a right side of another lane are same, the aggregation processing is performed based on information pieces relating to presence or absence of the lane marking on the left side of the one lane and information pieces relating to presence or absence of the lane marking on the right side of the other lane.

19. The non-transitory storage medium according to claim 17, wherein in the information processing method,
where the two adjacent lanes are lanes whose travel directions are opposite to each other,
if a lane marking on a right side of one lane and a lane marking on a right side of another lane are same, the aggregation processing is performed based on information pieces relating to presence or absence of the lane marking on the right side of the one lane and information pieces relating to presence or absence of the lane marking on the right side of the other lane, and
if a lane marking on a left side of one lane and a lane marking on a left side of another lane are same, the aggregation processing is performed based on information pieces relating to presence or absence of the lane marking on the left side of the one lane and information pieces relating to presence or absence of the lane marking on the left side of the other lane marking.

20. The non-transitory storage medium according to claim 15, wherein in the information processing method, fading of the lane marking is detected based on a rate of detection for the lane marking in a result of the aggregation processing.
